(19) United States
(12) Patent Application Publication
(10) Pub. No.: US 2025/0349932 A1
(43) Pub. Date: Nov. 13, 2025

(54) Blower and/or vacuum

(71) Applicant: Andreas Stihl AG & Co. KG, Waiblingen (DE)

(72) Inventors: Dennis Karl, Schwaigern (DE); Stefan Müller, Dettingen (DE); Florian Schumayer, Weilheim an der Teck (DE); Philipp Ehrat, Kornwestheim (DE); Sophie Ludwig, Waiblingen (DE)

(73) Assignee: Andreas Stihl AG & Co. KG, Waiblingen (DE)

(21) Appl. No.: 19/199,415

(22) Filed: May 6, 2025

(30) Foreign Application Priority Data
May 7, 2024 (DE) 102024112854.2

(51) Int. Cl. H01M 10/6563; A01G 20/47; B08B 5/02; F04D 25/06; F04D 29/32; F04D 29/58; H01M 10/613; H01M 10/623; H01M 50/247

(52) U.S. Cl. CPC H01M 10/6563; A01G 20/47; B08B 5/02; F04D 25/0673; F04D 29/325; F04D 29/584; H01M 10/613; H01M 10/623; H01M 50/247; H01M 2220/30

(57) ABSTRACT

A handheld blower and/or vacuum has a housing base body with a main flow duct in which a fan is arranged and through which main air flow flows when the blower is in operation. The housing has a handle having a cooling air duct that extends from an inlet opening on the main flow duct via a holding section of the handle up to an outlet opening. The inlet opening is assigned to a first end of the handle. When the blower is in operation, cooling air flow flows from the inlet opening of the handle to the outlet opening of the cooling air duct. An electronic structural unit is arranged in the handle in such a way that this electronic structural unit is cooled by the cooling air flow when the blower is in operation.

### CROSS-REFERENCE TO RELATED APPLICATION

This application claims the benefit of German Patent Application DE 102024112854.2, filed on May 7, 2024, the content of which is incorporated in its entirety.

### TECHNICAL FIELD

The disclosure relates to a handheld blower and/or vacuum and to a method for operating a handheld blower and/or vacuum.

### BACKGROUND

A handheld blower is known from the prior art, which comprises a housing, a blower unit arranged in the housing and having a fan, and a blower tube arranged on the housing. When the blower is in operation, air flows out of a blower tube opening in the blower tube. The blower is used, for example, to remove leaves or the like from pathways or lawns. The operator carries the blower when it is in operation.

### SUMMARY

It is an object of the disclosure to specify a blower and/or vacuum that combines a compact space with efficient operation. This object is solved by a blower and/or vacuum as disclosed and claimed.

The blower and/or vacuum comprises a housing having a housing base body, a blower unit arranged in the housing base body and having a fan, and a blower tube arranged on the housing base body. The blower unit has a drive motor. The blower unit has a fan wheel which can be driven by the drive motor to generate a main air flow. The housing base body has a main flow duct through which the main air flow flows when the blower and/or vacuum is in operation. The housing has a handle, wherein the handle is fixed via its first end to the housing base body. The handle has a cooling air duct that extends from an inlet opening on the main flow duct via a holding section of the handle up to an outlet opening, the inlet opening being assigned to the first end of the handle and arranged at an overpressure area of the main air flow. When the blower and/or vacuum is in operation, a cooling air flow flows from the inlet opening of the handle to the outlet opening of the cooling air duct. At least one electronic structural unit is arranged in the handle in such a way that this electronic structural unit is cooled by the cooling air flow when the blower and/or vacuum is in operation.

The handle of the blower known from the prior art serves merely as a holding handle for the purpose of holding and carrying the blower, but does not provide any additional space for stowing further components. The blower and/or vacuum according to the disclosure has a handle in which space is freed up, on the one hand, to arrange an electronic component in the handle and, on the other hand, to provide a cooling air duct that extends through the handle. By way of this cooling air duct, the electronic structural unit can be sufficiently cooled even when the blower and/or vacuum is in operation for relatively prolonged periods.

By moving the electronic structural unit from the housing base body to the handle, the housing base body can have a more compact design. A more compact design of the blower and/or vacuum in turn makes it easier for the operator to handle. By creating more free space in the housing base body, air can also be routed more efficiently in the housing base body. Thus, the blower and/or vacuum functions more efficiently.

The electronic structural unit is preferably a control unit. The control unit is preferably provided for controlling, regulating and monitoring the functions of the drive motor. The control unit preferably comprises at least one microprocessor. Preferably, the electronic structural unit comprises a circuit board as support for electronic components. The microprocessor in particular is arranged on the circuit board.

It is advantageously provided that the handle is assigned a control element for controlling the drive motor. The control element can be designed in particular as an operating lever, pivotable operating lever, slide, button, knob or the like. The control element preferably activates a switch. Preferably, the control element activates a potentiometer. It can also be provided that the control element activates both a switch and a potentiometer. It is advantageously provided that the switch or the potentiometer is arranged on the circuit board. Particularly preferably, both the switch and the potentiometer are arranged on the circuit board. If a switch and a potentiometer are provided, it can alternatively also be provided that only one of the two components is arranged on the circuit board and the other component is fastened elsewhere in the handle and connected to the circuit board.

It is advantageously provided that the inlet opening of the cooling air duct is arranged downstream of the fan wheel in relation to the main air flow. When the blower and/or vacuum is in operation, an overpressure area forms downstream of the fan wheel and a negative pressure area forms upstream of the fan wheel. Since the inlet opening of the cooling air duct lies in the high-pressure area, enough cooling air flows into the cooling air duct for pressure equalisation to cool the at least one electronic structural unit. Advantageously, the outlet opening of the cooling air duct is arranged in the handle in such a way that the cooling air flow exits the handle directly into the external environment of the blower and/or vacuum. The external environment of the blower and/or vacuum is preferably at atmospheric pressure. Preferably, the outlet opening lies outside the holding section 18 of the handle 15. In particular, it can also be provided that the cooling air flow is at least partially returned to the main air flow. Alternatively, it can also be provided that the cooling air flow is completely returned to the main air flow. Particularly advantageously, however, the cooling air flow is conducted completely out of the outlet opening directly into the external environment. The outlet opening is arranged downstream of the electronics unit in relation to the cooling air flow. The cooling air flow thus flows around and thereby cools the electronics unit. Subsequently, the cooling air flow that has been heated by the electronics unit can exit the handle from the outlet opening.

It is advantageously provided that the drive motor is an electric motor. Preferably, the drive motor is supplied with electrical energy via at least one battery pack arranged on the housing. In an alternative embodiment, it can also be provided that the blower and/or vacuum is connected to the power grid or to another power source via a cable. Particularly advantageously, the at least one battery pack is at least partially fixed in the handle of the blower and/or vacuum and arranged in the cooling air duct in such a way that at least the battery pack is cooled by the cooling air flow when the blower and/or vacuum is in operation. Preferably, at least the battery pack is arranged on the cooling air duct in such a way that the electrical connection of the battery pack is cooled by the cooling air flow when the blower and/or vacuum is in operation.

A further object of the disclosure is to specify a method for operating a handheld blower and/or vacuum that enables creation of a compact space in the blower and/or vacuum combined with efficient operation of the latter.

This object is solved by a method as disclosed and claimed.

The method provides for generating the main air flow by activation of the blower unit. A cooling air flow is branched off from the main air flow and directed into a cooling air duct, wherein the cooling air duct is located in a handle. The cooling air flow cools an electronic structural unit that is arranged in the handle and around which the cooling air flow flows.

An exemplary embodiment according to the invention is explained hereinafter with reference to the drawings:

### BRIEF DESCRIPTION OF THE DRAWINGS

FIG. 1 shows a perspective illustration of the work apparatus as a blower,

FIG. 2 shows a sectional illustration of the housing base body and the handle with cooling air duct of a blower according to FIG. 1,

FIG. 3 shows a simplified, schematic sectional illustration of the housing base body and the handle with cooling air duct of the blower according to FIG. 1, and

FIG. 4 shows a cross-section through the handle of the blower according to FIG. 1.

### DETAILED DESCRIPTION

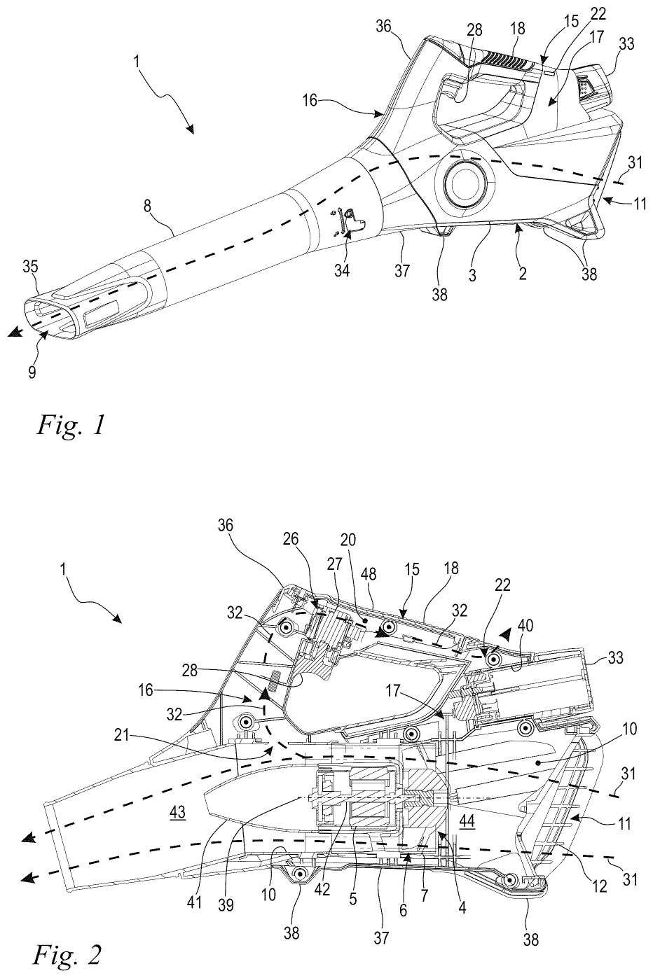

FIG. 1 shows a handheld, hand-carried blower 1. The work apparatus may also be a vacuum or a combined blower and vacuum. The blower 1 is used, for example, to remove leaves or the like from pathways and lawns. The blower 1 comprises a housing 2 and a blower tube 8 arranged on the housing 2. The housing 2 comprises a housing base body 3 and a handle 15 formed on the housing base body 3. The handle 15 is used to carry and guide the blower 1. In an alternative embodiment of the blower 1, a further handle may also be provided. The blower 1 also comprises a blower unit 4, the blower unit 4 being arranged in the housing 2, in particular in the housing base body 3 (FIG. 2). The blower unit 4 is used to generate an air flow 31. The air flow 31 is sucked in via an intake opening 11 in the housing 2, in particular in the housing base body 3. An intake grille 12 is provided in the intake opening 11 as access protection. The air flow 31 then passes via the blower unit 4 into the blower tube 8 and exits from a blower tube opening 9 into the external environment of the blower and/or vacuum. The air flow 31 exiting from the blower tube 8 can then be used to blow away leaves and the like.

As shown in FIG. 1, the blower tube 8 is arranged on the housing base body 3 of the housing 2. The blower tube 8 is releasably fastened to the housing base body 3. In the preferred exemplary embodiment, the blower tube 8 is fastened to the housing base body 3 via a bayonet closure 34. Other reversible connections may also be expedient for connecting the blower tube 8 and the housing base body 3. The distal end of the blower tube 8 is formed by an attachment 35 in the form of a nozzle. The attachment 35 is preferably fitted onto a main body of the blower tube 8. The attachment 35 is in particular reversibly fastened on the main body of the blower tube 8, whereby different outlet geometries can be provided on the blower tube 8 as required by changing the attachment 35. It can alternatively also be provided to design the main body of the blower tube 8 and the attachment 35 as one piece.

As shown in FIG. 1, the housing 2 of the blower 1 has a top side 36 and a bottom side 37. On the bottom side 37 of the housing 2, multiple feet 38 are provided so that the blower 1 can be set down. If the blower 1 is set down with its feet 38 on horizontal ground, the bottom side 37 of the housing 2 faces the ground and the top side 36 of the housing 2 faces away from the ground. In the preferred embodiment, the blower 1 comprises three feet 38. In an alternative embodiment, another number of feet may also be expedient. If the blower 1 is set down on the feet, then, in the exemplary embodiment, the blower tube 8 also lies with its distal end at least partially on the ground.

As shown in FIG. 2, the blower unit 4 comprises a fan 6 having a fan wheel 7 and comprises a drive motor 5 for driving the fan wheel 7. The fan wheel 7 can be driven to rotate about an axis of rotation 39. The fan wheel 7 is designed such that the air flow 31 in the region of the fan wheel 7 flows approximately parallel to the axis of rotation 39 of the fan wheel 7. Accordingly, the fan 6 is designed as an axial fan. The drive motor 5 is preferably designed as an electric motor. In an alternative embodiment, the drive motor 5 can also be designed as an internal combustion engine. The blower 1 furthermore comprises at least one battery pack 33 for supplying the drive motor 5 with electrical energy. In an alternative embodiment, multiple battery packs 33 may also be provided. It may also be expedient to supply the drive motor 5 with electrical energy in another way, for example by connecting the blower 1 by means of a cable to an available power grid or to some other power source.

As shown in FIGS. 1 and 2, the handle 15 is designed on the top side 36 of the housing 2. The handle 15 comprises a first end 16 and a second end 17. The handle 15 is attached via its first end 16 and its second end 17 to the housing base body 3 of the housing 2. The handle 15 is designed in particular as a loop handle. In an alternative embodiment, it can also be provided that the second end of the handle 15 is designed to be a free end. In such an embodiment, the handle 15 is attached to the base body 3 of the housing 2 only via its first end 16. In the present exemplary embodiment, the handle 15 and the housing base body 3 are formed from two housing shells that can be screwed together. In an alternative embodiment, it can also be provided that the handle 15 is formed from a handle housing designed separately from the housing base body 3.

As shown in particular in FIG. 2, the blower 1 comprises a battery compartment 40 into which the at least one battery pack 33 can be inserted. If the battery pack 33 is depleted, it can be charged either using an external charging device (not shown in detail) or by being inserted into the battery compartment 40. The battery compartment 40 is formed on the housing base body 3. The battery compartment 40 is formed in the region of the second end 17 of the handle 15. The battery compartment 40 is formed above the intake opening 11, in relation to a state in which the blower 1 is set down on horizontal ground.

As shown in FIGS. 1 and 2, the blower 1 comprises a control element 28 for controlling the drive motor 5, in particular for controlling the speed of the drive motor 5. The control element 28 is designed in the preferred exemplary embodiment as a slide that is mounted such that it can move linearly. The slide is preloaded in an inoperative position by a spring not shown in detail. To actuate the drive motor 5, the operator has to push the slide counter to the spring force into an operating position. In an alternative embodiment, the control element 28 can also be designed as a lever, in particular pivot lever, a button, a knob or the like. The control element 28 is assigned to the handle 15, i.e. the operator can, when gripping the handle 15 with one hand, use the same hand to actuate the control element 28. The control element 28 is preferably arranged on the handle 15. Furthermore, the blower 1 comprises a switch (not shown in more detail), in particular a microswitch, that can be actuated by the actuating element 28. When the switch is actuated, it transmits a corresponding signal to a control unit 26. The control unit 26 is preferably provided for controlling, regulating and monitoring the functions of the drive motor 5. The control unit 26 preferably comprises at least one microprocessor. Preferably, the control unit 26 comprises a circuit board 27 as support for electronic components. The microprocessor in particular is arranged on the circuit board 27. The control unit 26 processes the signal from the switch actuated by the control element 26, thereby controlling the speed of the drive motor 5. In the preferred embodiment, a potentiometer (not shown in more detail) that is operatively connected to the control element 26 is also provided. The potentiometer is also connected to the control unit 26, which in turn processes the signal from the potentiometer to control the speed of the drive motor 5. In the particularly preferred exemplary embodiment, the switch and/or the potentiometer are arranged on the circuit board 27 of the control unit 26. The switch and/or the potentiometer are preferably arranged directly on the circuit board 27 of the control unit 26.

As shown in FIG. 2, the blower 1 comprises a main flow duct 10. The main flow duct 10 passes from the intake opening 11 in the housing base body 3 through the housing base body 3 to blower tube 8 and ends at the blower tube opening 9. The fan 6 is arranged in the housing base body 3 in the main flow duct 10. The drive motor 5 is surrounded by a flow guide element 41 to reduce flow resistance in the main flow duct 10 and additionally to direct the air flow 31 towards the blower tube 8. A drive shaft 42 of the drive motor 5 protrudes from the flow guide element 41 and drives the fan wheel 7 in rotation about the axis of rotation 39. The fan wheel 7 is located on that side of the drive shaft 42 that faces the intake opening 11.

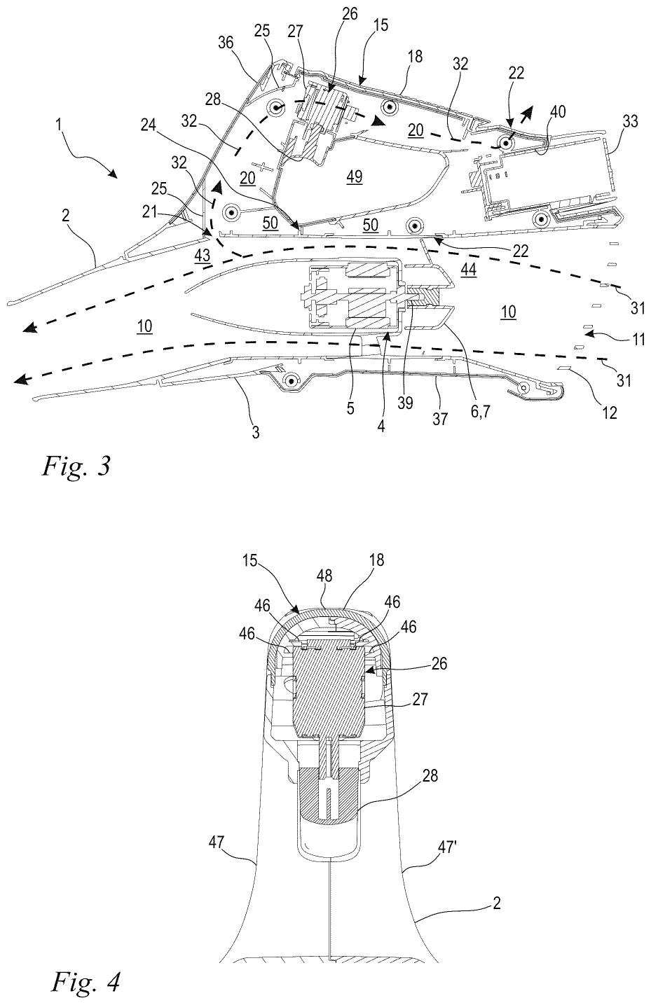

As shown in FIGS. 2 and 3, the handle 15 is designed in such a way that it forms a cooling air duct 20 to guide a cooling air flow 32 through the handle 15. The cooling air duct 20 extends from an inlet opening 21 towards an outlet opening 22. The inlet opening 21 is formed on the housing base body 3 towards the main flow duct 10. Thus, the main flow duct 10 and the cooling air duct 20 are flow-connected to one another via the inlet opening 21. The inlet opening 21 is assigned to the first end 16 of the handle 15, so that the cooling air flow 32 flows via the first end 16 of the handle 15 into the handle 15 via the inlet opening 21. The cooling air duct 20 extends further over the holding section 18 of the handle 15, the holding section 18 being that region of the handle 15 where the operator normally grasps the handle 15 when the blower 1 is in operation. In the advantageous embodiment, the outlet opening 22 is formed on the handle 15 in such a way that the cooling air flow 32 can flow out of the cooling air duct 20 of the handle 15 directly into the external environment outside the housing 2. The outlet opening 22 is arranged adjacent to the second end 17 of the handle 15. The outlet opening 22 is preferably arranged between the holding section 18 and the second end 17 of the handle 15. The outlet opening 22 is preferably arranged outside the holding section 18. The outlet opening 22 is preferably arranged downstream of the electronic structural unit 26 arranged in the handle 15. Particularly preferably, a heat sink that facilitates efficient heat exchange of the electronic structural unit 26 is provided on the electronic structural unit 26. The cooling air flow 32 is therefore branched off from the air flow 31 from the main flow duct 10 when the blower 1 is in operation. The cooling air flow 32 passes from the main flow duct 10 via the inlet opening 21 into the cooling air duct 20, past the first end 16 of the handle 15, through the holding section 18 of the handle 15 and out of the cooling air duct 20 via the outlet opening 22. In the process, components that are arranged in the handle 15 are cooled by the cooling air flow 32. The at least one electronic structural unit 26, presently designed as a control unit 26, is provided in the handle 15. Multiple electronic structural units may also be arranged in the handle 15 in order to make use of the free space in the handle 15 and provide a compact housing base body 3. Since the cooling air duct 20 is provided in the handle 15, components requiring cooling during operation of the blower 1 can also be arranged in the handle. The control unit 26, including its circuit board, the switch and/or the potentiometer, is arranged in the cooling air duct 20 of the handle 15. Particularly advantageously, parts of the power electronics are also arranged in the cooling air duct 20, in the present case the electrical ports of the battery compartment that direct the electrical energy of the battery pack 33 to the control unit 26 and to the drive motor 5.

As shown in FIGS. 2 and 3, an overpressure area 43 and a negative pressure area 44 are provided in the main flow duct 10. The overpressure area 43 lies downstream of the fan wheel 7 in relation to the air flow 31. The negative pressure area 44 lies upstream of the fan wheel 7 in relation to the air flow 31. The inlet opening 21 of the cooling air duct 20 preferably lies in the overpressure area 43. In an alternative embodiment of the blower 1, it can be provided that at least one further outlet opening of the cooling air duct 20 opens into the negative pressure area 4. As a result, at least part of the cooling air flow 32 can flow out of the handle 15 and back into the negative pressure area 44 of the main flow duct 10, while the remaining part flows directly out of the handle 15 via the outlet opening 22 into the external environment of the blower and/or vacuum. Particularly advantageously, the outlet opening 22 lies downstream of the power electronics in relation to the cooling air flow 32. The power electronics electrically connects the battery pack 33 in the battery compartment 40. This advantageous arrangement of the outlet opening allows the power electronics to be cooled. Particularly preferably, the outlet opening 22 is arranged such that the battery pack is at least partially cooled.

FIG. 4 shows a cross-section of the handle 15 through the control unit 26, in particular through the control element 28. The circuit board 27 of the control unit 26 is held on a holding device 45 in the handle 15. The holding device 45 comprises bar-like holding elements 46, in which the circuit board 27 is fixedly clamped. As already mentioned above, the housing base body 3, like the handle 1, is substantially formed by two housing shells 47, 47′. During assembly, the individual parts located in the housing 2 are first assembled in one of the two housing shells 47, 47′. The other housing shell 47, 47′ is then attached. The bar-like holding elements 46 are moreover also used as flow guide elements which guide the cooling air flow 32 in a targeted manner along the control unit 26 in order to cool same.

As shown in FIG. 3, the work apparatus 1 comprises an additional flow guide element 24. The handle 15 has a handle opening 49. The holding section 18 is fixed above the handle opening 49. Below the handle opening 49, an interior 50 is designed between the main flow duct 10 and the handle opening 49. The interior 50 extends from the inlet opening 21 of the cooling air duct 20 below the handle opening 49 towards the outlet opening 22. So that the cooling air flow 32 does not flow from the inlet opening 21 of the cooling air duct 20 below the handle opening 49 to the outlet opening 22 of the cooling air duct 20, the additional flow guide element 24 is provided to interrupt the flow. The additional flow guide element 24 is arranged between the handle opening 49 and a partition wall to the main flow duct 10 and prevents a flow connection between the inlet opening 21 and the outlet opening 22 below the handle opening 49. This can ensure that the entire cooling air flow 32 is guided directly past the electronic component 26 in order to cool the latter. The additional flow guide element 24 is presently formed from two mutually contacting ribs of the housing 2.

As shown in FIG. 3, the work apparatus 1 comprises a further, additional flow guide element 25. The further, additional flow guide element 25 is used in particular to close so-called dead spaces adjoining the cooling air duct 20. Thus, the cooling air flow 32 does not flow in dead spaces of the housing 2, but is directed via the further, additional flow guide element 25 to the electronic structural unit 26 by the shortest possible route. Such a further, additional flow guide element 25 in particular delimits cavities of the housing 2, which are located in corners of the housing 2, in particular of the handle, from the cooling air duct 20. Such a further, additional flow guide element 25 is preferably arranged at the inlet opening 21 and delimits a dead space of the handle 15 towards the distal end of the blower tube 8 with respect to the cooling air duct 20. A further, additional flow guide element 25 is arranged at an upper corner of the handle 15, above the handle opening 49, with the further, additional flow guide element 25 delimiting the corner space of the handle 15 from the cooling air duct 20.

As shown in FIG. 4, the handle 15 comprises a handle cover 48, which is fitted on the two housing shells 47, 47′ to complete the holding section 18 of the handle 15. The handle cover 48 is preferably made of a material that allows the hand to have a particularly good grip on the handle 15.

As shown in FIG. 4, the circuit board 27 comprises a contour 49, with parts of the contour 49 of the circuit board 27 being at a distance from the housing 2, thereby allowing the cooling air flow 32 to flow past the circuit board 27 when the blower 1 is in operation. The more space there is between the circuit board 27 and the housing 2, the better the flow of the cooling air 32 around the circuit board 27 and the better the associated cooling capacity.

What is claimed is:

1. A handheld blower, comprising:
a housing (2) having a housing base body (3);
a blower unit (4) arranged in the housing base body (3) having a fan (6); and
a blower tube (8) arranged on the housing base body (3),
wherein the blower unit (4) has a drive motor (5), and
wherein a fan wheel (7) of the fan (6) is driven by the drive motor (5) to generate a main air flow (31),
wherein the housing base body (3) has a main flow duct (10) through which the main air flow (31) flows when the handheld blower (1) is in operation,
wherein the housing (2) has a handle (15), the handle (15) being fixed via a first end (16) to the housing base body (3),
wherein the handle (15) has a cooling air duct (20) that extends from an inlet opening (21) on the main flow duct (10) via a holding section (18) of the handle (15) up to an outlet opening (22),
wherein the inlet opening (21) is coupled to the first end (16) of the handle (15) and arranged at an overpressure area of the main air flow (31), and
wherein a cooling air flow (32) flows from the inlet opening (21) of the handle to the outlet opening (22) of the cooling air duct (20) when the handheld blower (1) is in operation, and
wherein an electronic structural unit (26) is arranged in the handle (15) whereby the electronic structural unit is cooled by the cooling air flow (32) when the handheld blower (1) is in operation.

2. The handheld blower according to claim 1,
wherein the electronic structural unit (26) is a control unit.

3. The handheld blower according to claim 1,
wherein the electronic structural unit (26) comprises a circuit board (27) as support for electronic components.

4. The handheld blower according to claim 3,
wherein the handle (15) is coupled to a control element (28) for controlling the drive motor (5).

5. The handheld blower according to claim 4,
wherein the control element (28) activates a switch and/or a potentiometer, and
wherein the switch and/or the potentiometer are arranged on the circuit board (27).

6. The handheld blower according to claim 1,
wherein the outlet opening (22) of the cooling air duct (20) is arranged in the handle (15) such that the cooling air flow (31) exits the handle (15) directly into an external environment of the blower.

7. The handheld blower according to claim 1,
wherein the outlet opening (22) is arranged downstream of the electronics unit (26) in relation to the cooling air flow (31).

8. The handheld blower according to claim 1,
wherein the drive motor (5) is an electric motor, and
wherein the drive motor (5) is supplied with electrical energy via at least one battery pack (33) arranged on the housing (2).

9. The handheld blower according to claim 8,
wherein the at least one battery pack (33) is at least partially fixed in the handle (15) and is cooled by the cooling air flow (32) when the handheld blower (1) is in operation.

10. A method for operating a handheld blower,
wherein the blower comprises
a housing (2) having a housing base body (3),
a blower unit (4) arranged in the housing base body (3), and
a fan (6),
wherein the blower unit (4) has a drive motor (5),
wherein a fan wheel (7) of the fan (6) can be driven by the drive motor (5) to generate a main air flow (31),
wherein the housing (2) has a handle (15), and
wherein the handle (15) is fixed via a first end (16) to the housing base body (3),
the method comprising:
generating the main air flow (31) by activating the blower unit (4);
branching off a cooling air flow (32) from the main air flow (31) into a cooling air duct (20) formed in the handle (15); and
cooling an electronic structural unit (26) arranged in the handle (15) by the cooling air flow (32) flowing around the electronic structural unit (26).
